(19) United States
(12) Patent Application Publication
(10) Pub. No.: US 2016/0034474 A1
(43) Pub. Date: Feb. 4, 2016

(54) Enterprise Data Mining in a Multi-Tenant Database

(71) Applicant: Michael Anthony ROGERS, Kelowna (CA)

(72) Inventor: Michael Anthony ROGERS, Kelowna (CA)

(21) Appl. No.: 14/879,957

(22) Filed: Oct. 9, 2015

Related U.S. Application Data
(63) Continuation of application No. 13/683,827, filed on Nov. 21, 2012, now abandoned.

(51) Int. Cl. G06F 17/30

(52) U.S. Cl. CPC G06F 17/3056; G06F 17/30864; G06F 17/30507; G06F 17/30339

(57) ABSTRACT

An enterprise software system connected to multi-tenant hosted software offered in a cloud computing environment having the capacity to serve a large number of users with a small number of servers, and means for collecting and reporting statistically relevant information based on an aggregation of the data within the multi-tenant database. The integrated software modules include modules for IT management, financial operations, portfolio management, project management, project budget management, resource management, and operations management. The system permits user-specific lexicography mapped to a Master terminology; ranking projects on financial and non-financial indicators; presentation of a dynamic dashboard of proposals and approved projects; provision of a service catalogue that incorporates budget and asset management processes; a multi-tenanted database that enables users to share data management resources while maintaining their data in confidence; and providing aggregate IT data for competitive intelligence purposes.

### FIELD OF THE INVENTION

The present invention relates to a system for management of information technology resources within an enterprise. In particular, the invention relates to a computer-implemented system for managing multiple enterprise information technology resources.

### BACKGROUND OF THE INVENTION

There are several challenges facing information technology (‘IT’) departments within companies. They are continually challenged to do more with the same or less resources. They are not adequately involved in business planning. They must compete for investment against other business priorities. Changes in regulatory requirements may add expense and cycle time.

In order to succeed and contribute to the success of the enterprise, the IT departments must be able to make informed resource decisions, effectively manage competing or conflicting priorities, use internal processes to manage IT service delivery, and promote the IT function within the enterprise.

At present, IT departments must purchase software from multiple vendors and integrate it for their company. Gaps may exist where suitable software offerings are not available. There is a need for computer-implemented systems which enable IT departments to overcome these challenges and fulfill their many functions effectively. Future solutions will include on-demand product delivery which will effect changes in traditional software distribution and deployment. A new approach to software distribution is termed ‘cloud computing’.

Cloud computing refers to the use of Internet (“cloud”) based computing, storage and connectivity technology for a variety of different services. The pervasiveness of the Internet, along with the dramatic decline in the pricing of the technology components has enabled this new generation of computing, in which dynamically scalable and often virtual resources are provided as a service to both enterprises and consumers. Users need not have knowledge of, expertise in, or control over the technology infrastructure “in the cloud” that supports them. In the context of enterprise business applications, cloud computing fundamentally changes the way business applications are developed and deployed. Application developers no longer need to create and manage their own infrastructure of servers, storage, network devices, operating system software and development tools in order to create a business application. Instead, the entire infrastructure is managed in the cloud, and developers simply use an Internet browser to access the development environment. Application users are able to gain access to a variety of business applications via an Internet browser or mobile device, and are able to take advantage of a robust, secure, scalable and highly available application at a relatively low cost, without the cost and complexity of managing the application.

Software-as-a-Service (‘SaaS’) uses cloud computing to enable businesses to access a wide variety of software application services deployed over the Internet on an as-needed basis, without in-house installation and maintenance. With traditional enterprise software applications, companies must maintain support for many versions of their software and ensure it remains compatible with a variety of changing hardware and operating systems. With the advent of SaaS as a business model has come the challenge of providing a secure data architecture that will satisfy users who are concerned about surrendering control of their vital business data to a third party.

Enterprise cloud computing, which refers to business applications that are developed using the cloud and a technology platform that customers and developers use to build and run business applications, includes both application SaaS for users and platform SaaS for developers.

SaaS is currently an expanding movement in technology that, at its core, provides a centralized architecture upon which a single instance of the software will run that will serve multiple clients (organizations) or tenants. The software industry does not universally accept or support the principle of multi-tenant databases and as such, there is a limited amount of guidance available to support development of a true SaaS system.

### SUMMARY OF THE INVENTION

In one of its aspects, the invention comprises a computer-implemented method of enterprise data mining comprising the steps of collecting data from a plurality of users of a multi-tenant hosted database in a cloud computing environment; selecting data that is relevant to a desired output from among the collected data; pre-processing the selected data by comparing data among a selected sub-group of users; and generating a report from the data in response to a received request from a client.

In another of its aspects, the system architecture may include a rules engine and a related Rete algorithm to enhance the speed of collection and abstraction of data from the database. The data pertaining to each user may be associated with an encryption key unique to that user. In another aspect, all of a plurality of users may map a user-specific lexicography to a master terminology.

According to another aspect of the invention, a project being managed may be ranked for priority according to both financial and non-financial criteria, and both approved projects and proposed projects may be simultaneously viewed and managed.

In another aspect of the invention, there is provided a computer-implemented method in an enterprise cloud computing system for information technology management and data extraction in a multi-tenant environment, comprising the steps of providing a set of multi-tenant hosted software modules; providing access to the software modules to each of a plurality of remote users via the Internet through web browsers; providing a multi-tenant shared database associated with the software modules; providing means for collection of user data within the multi-tenant database; providing means for aggregation of the data; providing means for manipulation of the data; and providing means for reporting of the data. The set of software modules may comprise one or more of an information technology management module; a financial management module; a portfolio management module; a project management module; a resource management module; and an operations management module.

In another aspect, each user may use metadata to configure the set of software modules to user-specific specifications without altering other users' metadata configurations.

In a further aspect, the invention comprises a database system in a cloud computing system comprising a database server, which stores a plurality of databases; a control server for controlling the database system, wherein the control server comprises means for accessing and operating any one or more of a set of software modules associated with the database server, wherein the database is used to store for each user of the application: information technology management information; financial information; portfolio management information; project management information; resource management information; and operations management information. The control server may further comprise means for preventing access by each user to the data of any other user.

### BRIEF DESCRIPTION OF THE DRAWINGS

A detailed description of the preferred embodiments is provided by way of example only and with reference to the following drawings, in which:

FIG. 1 is a depiction of the dashboard screen of the present invention;

FIG. 2 is a depiction of the system setup screen of the present invention;

FIG. 3 is a depiction of the company information screen of the present invention;

FIG. 4 is a depiction of the users and rolls screen of the present invention;

FIG. 5 is a depiction of the organizational layout screen of the present invention;

FIG. 6 is a depiction of the services screen of the present invention;

FIG. 7 is a depiction of the vendor screen of the present invention;

FIG. 8 is a depiction of the resources screen of the present invention;

FIG. 9 is a depiction of the business terms screen of the present invention;

FIG. 10 is a depiction of the goals screen of the present invention;

FIG. 11 is a depiction of the work request central screen of the present invention;

FIG. 12 is a depiction of the work request summary information screen of the present invention;

FIG. 13 is a depiction of the project central screen of the present invention;

FIG. 14 is a depiction of the project summary screen of the present invention;

FIG. 15 is a depiction of the resource central screen of the present invention;

FIG. 16 is a depiction of the budgets central screen of the present invention;

FIG. 17 is a depiction of the service catalog central screen of the present invention;

FIG. 18 is a depiction of the services table screen of the present invention;

FIG. 19 is a depiction of the systems table screen of the present invention;

FIG. 20 is a depiction of the configuration items screen of the present invention; and

FIG. 21 is a depiction of the vendors management screen of the present invention.

In the drawings, one embodiment of the invention is illustrated by way of example. It is to be expressly understood that the description and drawings are only for the purpose of illustration and as an aid to understanding, which are not intended as a definition of the limits of the invention.

### DETAILED DESCRIPTION OF THE INVENTION

In one of the aspects of the system of the present invention there is provided an enterprise software system which is deliverable through web browsers and which connects to multi-tenant hosted software. The software is offered via the Internet, that is, as cloud computing, thereby permitting end users to avoid the expense and complexity of traditional software procurement and implementation.

There is provided a multi-tenant shared database with shared schema having the capacity to serve a large number of users with a small number of servers, thereby reducing the cost per user.

There is further provided means for collecting and reporting statistically relevant information based on an aggregation of the data within the multi-tenant database. By virtue of having data from multiple users stored in one database, real-time information such as key performance indicators may be obtained without compromising database performance. The present invention permits the collection, normalization, manipulation and reporting of such data.

It is an object of the present invention to provide a system which may be used to collect, aggregate and report data in real-time in a multi-tenant framework. The system is scalable, multi-tenant-efficient and configurable.

The system of the present invention comprises a set of integrated software modules, including the following:
1. IT Management Module for providing management information related to the IT services of the company, including support activities, performance, operating expense and budget performance, system health, data health, and project status.
2. Financial Module for establishing and managing operating and capital budgets, managing computing assets, providing structures and processes for cost allocations, and controlling spending approvals.
3. Portfolio Management Module for managing and coordinating investment and request pipelines, analysing and providing investment decision criteria, and tracking software assets, value and performance.
4. Project Management Module for managing project budgets, providing project status and management reporting, and facilitating project reviews with management and project teams.
5. Resource Management Module for managing and communicating organization structure, roles and responsibilities, IT employee and contingent workforce management, resource allocation, cost management and skills development.
6. Operations Management Module for providing daily operational services, maintaining system availability, communicating system status, maintaining equipment, providing enterprise support services, and controlling and managing production changes.

The system of the present invention may be offered to users via web-browser and may be purchased as a subscription service. Deployment is rapid as users need not spend time procuring, installing or maintaining servers, storage, networking equipment, and security products.

In another of its aspects, there is provided a data commercialization system. The invention comprises a multi-tenant database whose data may be mined for commercial distribution to enable users to compare aspects of their business performance against other relevant users.

In order to provide a service that users from multiple client companies can concurrently connect to and use to store data, an architecture is created which maximizes the sharing of resources between tenants and is able to differentiate the data that belongs to each tenant. The architecture is robust and secure in order to satisfy customers that the SaaS system maintains the privacy of their data.

By designing a configurable system, flexibility is provided to the various users from different companies. As the system is designed to be multi-tenanted, users are permitted to use metadata to configure the look and feel of the application without changing the behaviour for other users. The configuration methods are designed to be easy for the end-user and do not incur extra performance costs for each configuration instance. At the same time, the system will channel users into choosing the preferred options for their industry or sector type.

Regardless of the size of database and the number of tenants, the architecture and algorithms support the ability to provide all page loads in 8 seconds or less and return query results in 30 seconds or less. With prior art technology, query results often require 2 to 30 minutes. Strategies of pre-aggregation and selective de-normalization are used to anticipate which analysis or measurement any end-user could reasonably need or request. With this advancement in methodology, each time there is a material change in the database, the system is able to determine which analyses or metrics require updating and queue the data for aggregation and manipulation.

Managing IT software resources is a challenge for many businesses. No fully integrated solutions exist that provide, in a cohesive unit, a method of granular information tracking, the ability to report at a granular level, and the ability to improve upon the data by presenting to the user recommendations based on analysis of the data in comparison to data from other tenants in the same industry sector. Without these capabilities present in a single unit, obtaining the results would take days.

The system of the present invention includes the development of a new architecture that includes a rules engine and a related Rete (pattern-matching) algorithm that allows for the collection and abstraction of data in real time. This Rete algorithm is capable of seeking patterns in the data and forms the basis of an artificial intelligence system able to analyze information and provide meaningful recommendations based on its findings. The present invention has broad application in the field of business intelligence by providing statistically relevant, aggregated real-time data.

The invention comprises a multi-tenant database that will safely and securely store data in an encrypted format and will utilize a fingerprint algorithm for authentication.

The system of the present invention is capable of storing and manipulating large amounts of data, without compromising performance. According to the system of the present invention, one customer is unable to view another customer's data at any time. To achieve an appropriate level of security, a unique encryption key is used for each tenant's data.

Novel aspects of the system of the present invention include, without limitation, the capacity of the system to permit use by a user of a user-specific lexicography mapped to a Master terminology; the ability to score and rank projects on the basis of a combination of financial and non-financial indicators; presentation of a dynamic dashboard of proposals and approved projects; provision of a service catalogue that incorporates budget and asset management processes; a multi-tenanted database that enables users to share data management resources while maintaining their data in confidence; and providing aggregate IT data for competitive intelligence purposes.

In operation, the system of the present invention is accessed by logging on through an internet browser to the Internet through a designated Uniform Resource Locator (URL) web address. Access to the website preferably is only available through prior registration and use of a user name and password.

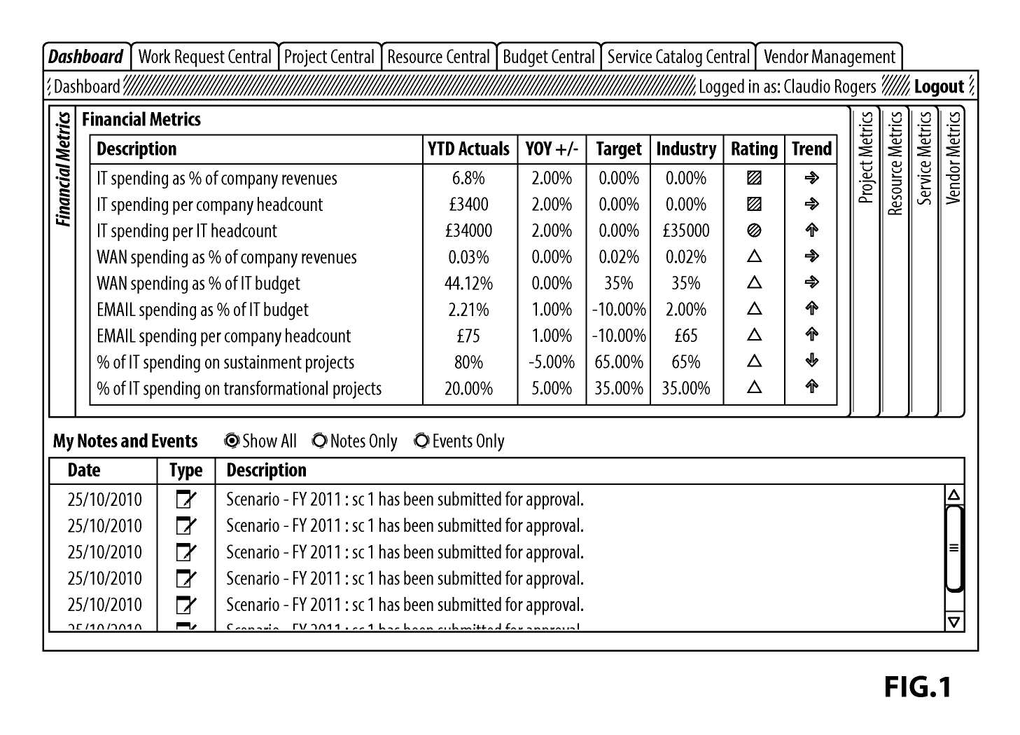

Upon accessing the website, the user will be presented with the Dashboard screen, as depicted in FIG. 1.

The Dashboard provides the user with an overview of its enterprise technology by key metric. It provides and compares benchmarks of actuals, targets and industry averages. For example, industry average benchmarks may be set at a value of 100. An actual value of 100 would indicate that the user's actuals were industry average. The Dashboard also provides information relating to key dates and reminders of those dates.

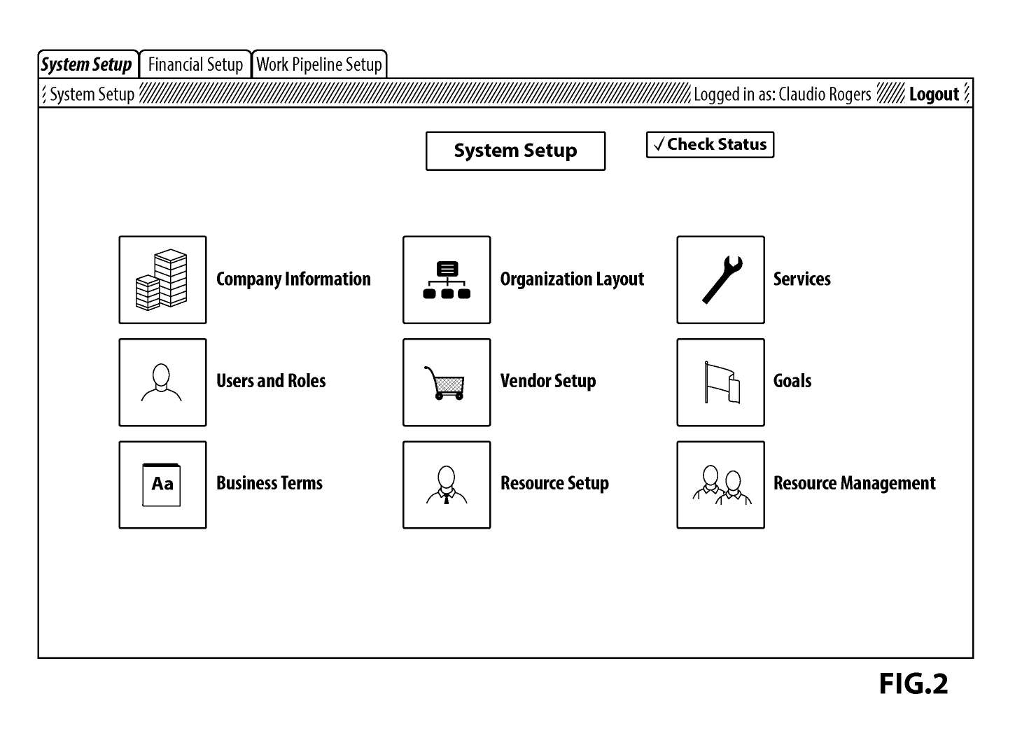

The Enterprise Technology Management tool will require initial setup. To conduct setup operations, the user may click on the tab ‘System Setup’ to load the System Setup Screen shown in FIG. 2.

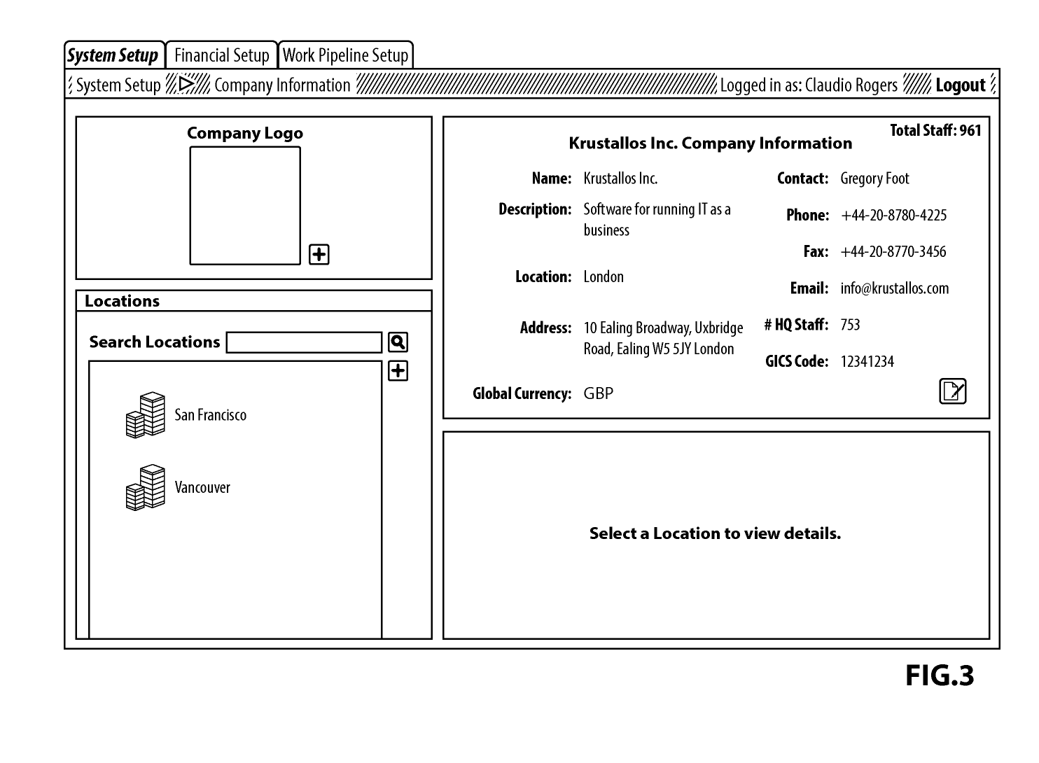

By selecting the ‘Company Information’ icon, the Company Information screen of FIG. 3 will be loaded. Company name, address, contacts and locations may be added, deleted or amended here. Locations, Teams, IT Owners and Business Sponsors may be created, deleted or edited at this screen and will be linked throughout the tool.

Changes are saved before moving to another screen, using the ‘Save’ and ‘Update’ icons. Selection of the ‘ETM Main’ icon will take the user out of the Setup screens and back to the Dashboard screen.

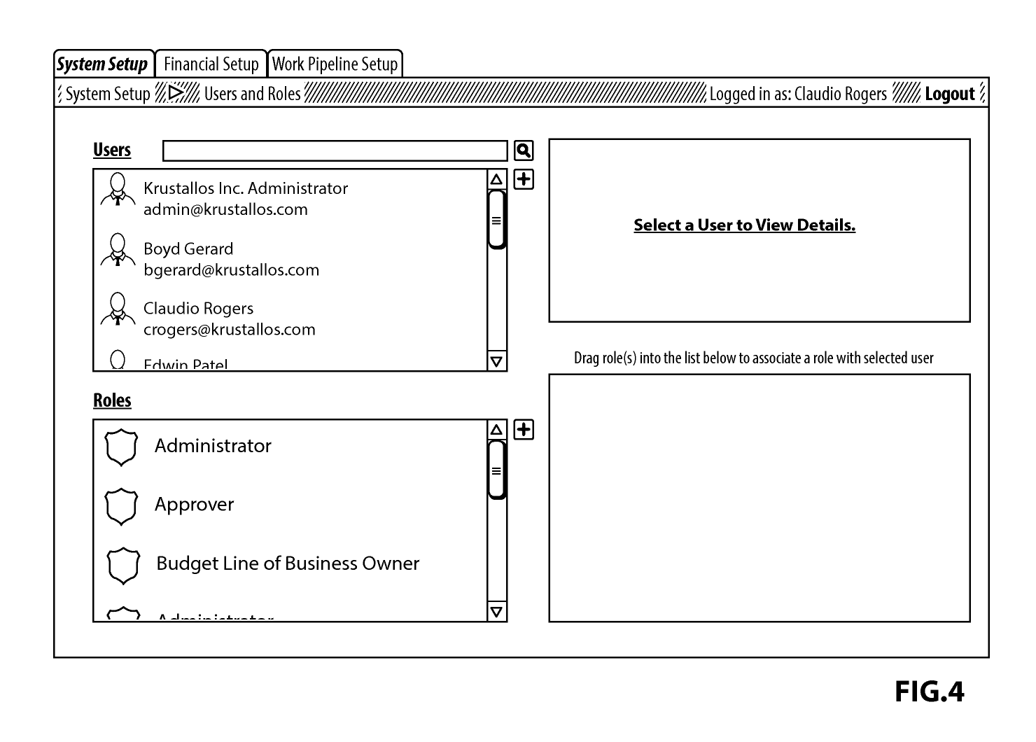

From the System Setup screen, the user may select ‘Users & Roles’ to load the screen of FIG. 4. The user may use the scroll bar or search menu to locate and select the desired User or Role. At this screen, new Users may be added, deleted or amended, and Roles may be assigned or removed from Users.

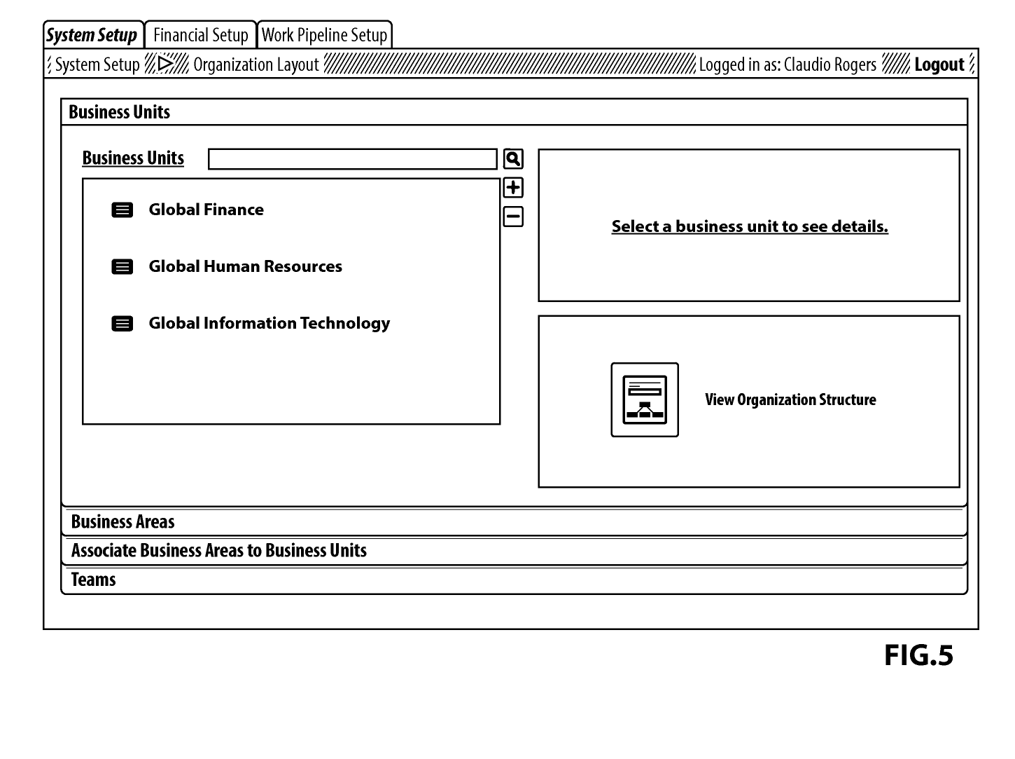

The user may select Organizational Layout from main System Setup screen to load the screen depicted in FIG. 5.

The user may select the desired Business Unit or Business Area, and may add, delete or amend Business Areas or Business Units.

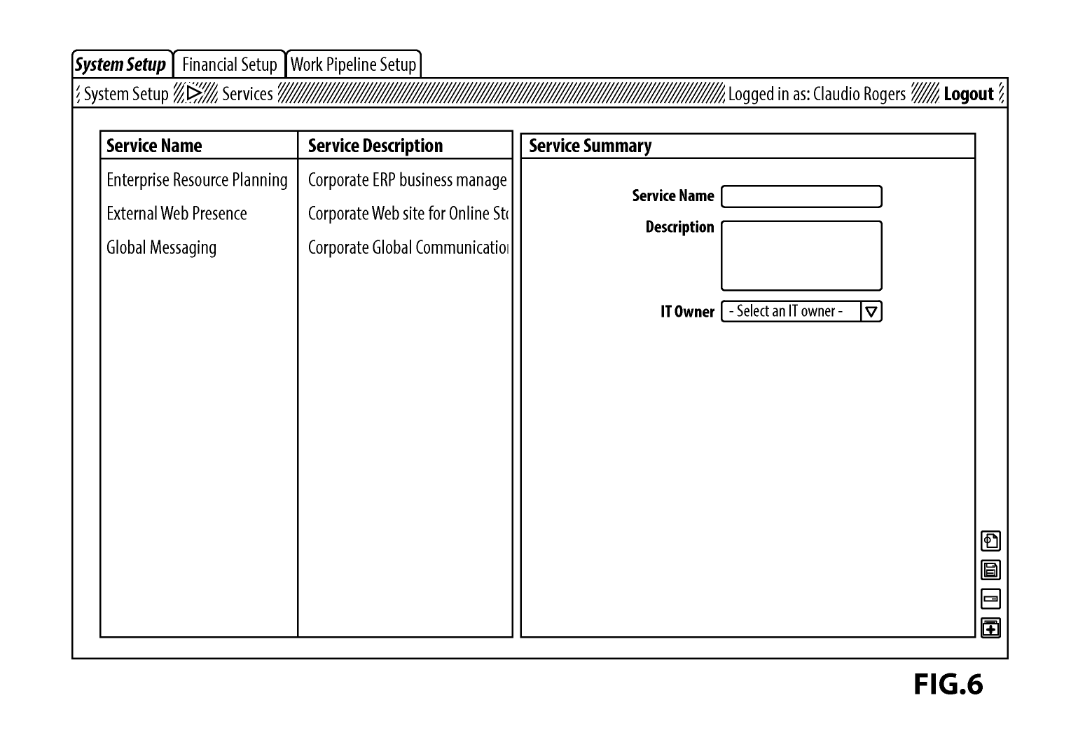

The user may select Services from main System Setup screen to load the Services screen depicted in FIG. 6. New Services may be added by entering the Service name and description and assigning the IT owner for the Service through drop down menu selection. Services may be deleted or amended also.

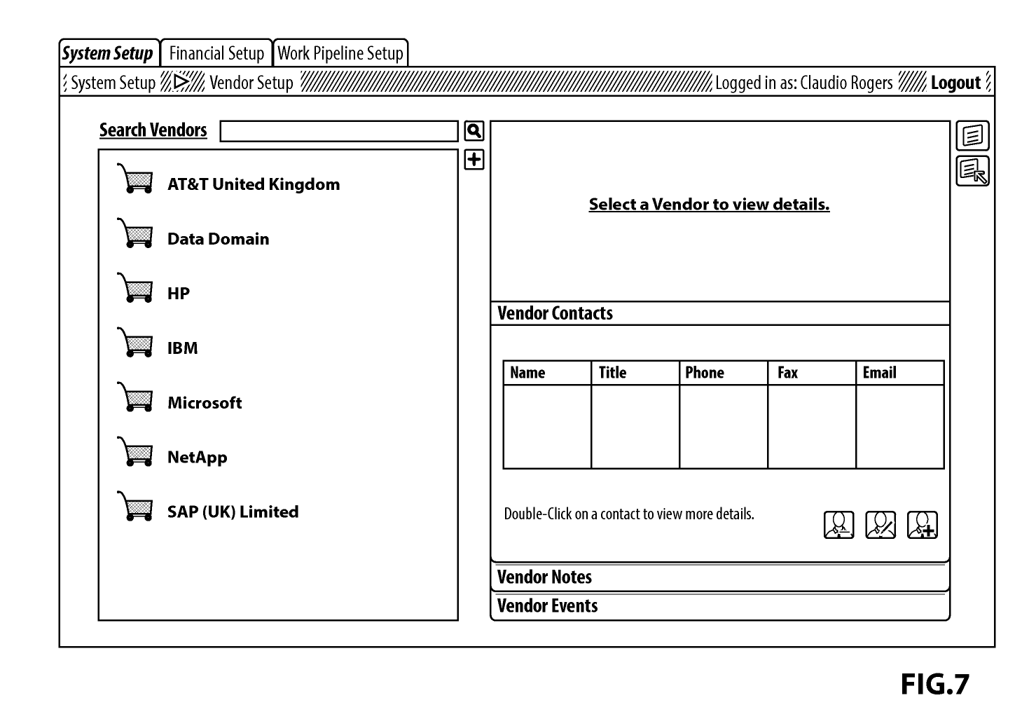

Users may select the Vendor screen shown in FIG. 7 from the System Setup screen. The user may import Vendor data compatible with data upload specifications and templates from personal or shared drives. Vendors may be viewed, added, deleted or edited at this screen. The user may also add or edit Vendor Contacts, Notes or Events at this screen.

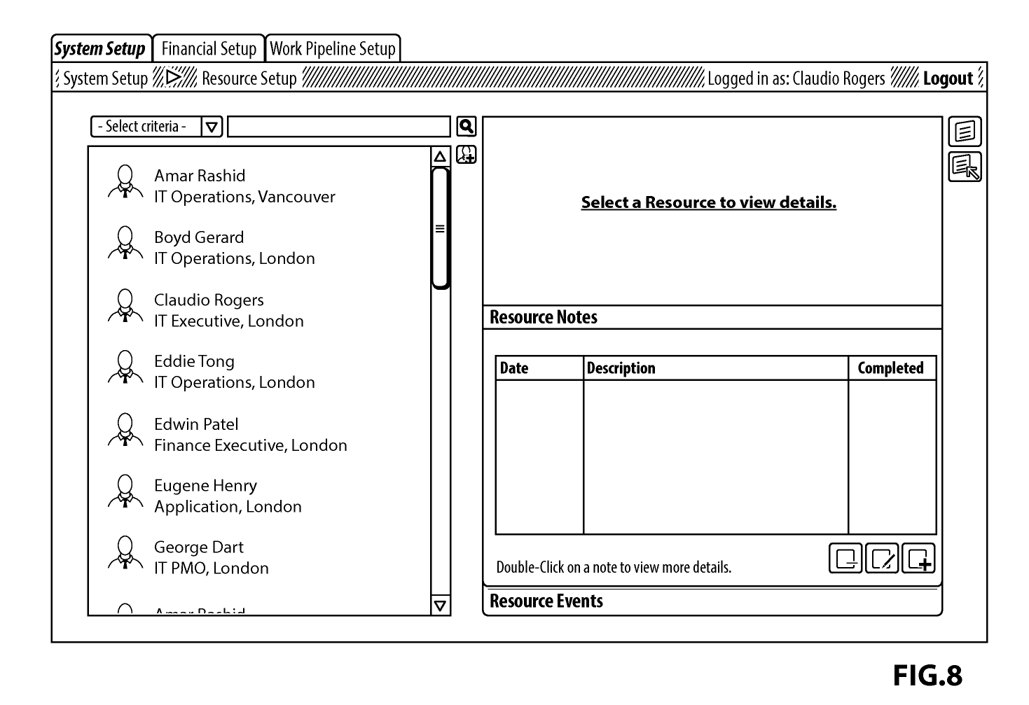

The user may select Resources at the main System Setup screen to load the Resources screen shown in FIG. 8. The user may import, add, delete or edit Resources through this screen.

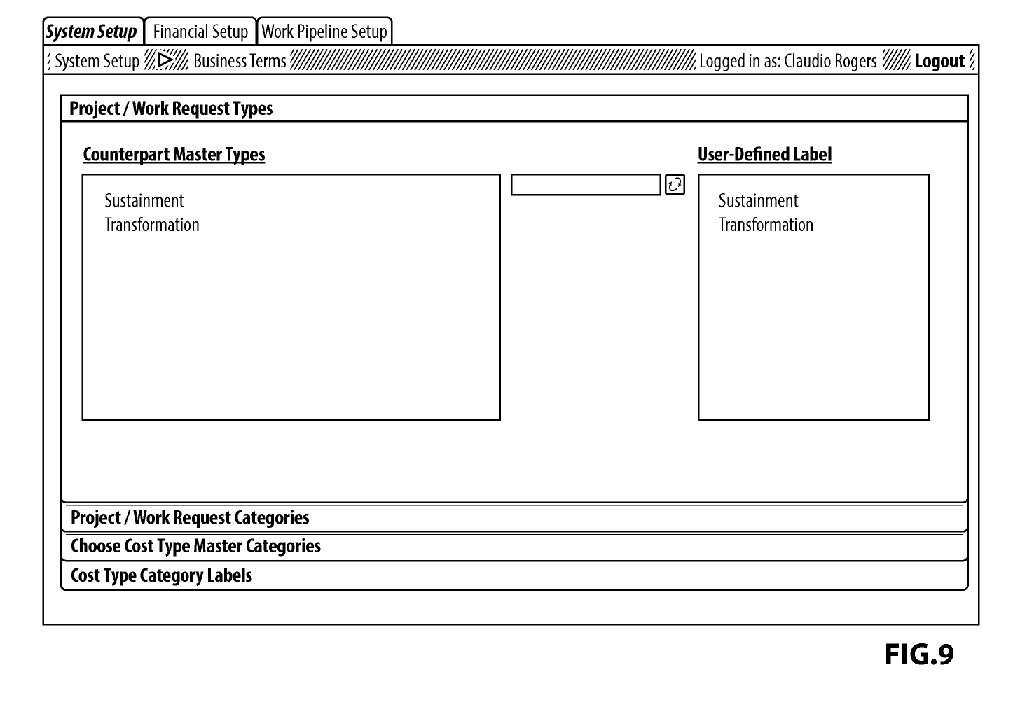

The user may select the Business Terms icon at the main System Setup screen to load the Business Terms screen of FIG. 9. The user may input its company's terms of business terminology, for example, its naming conventions for project and work request types and categories, cost types and project objectives. This allows the user's company the freedom to use its own terminology throughout the system. If no changes are made by the user to the Business Terms set up screen, standard master terminology will be used. The user may correlate its company's terminology to the Master terminology by selecting a Master term, then typing the corresponding company's term.

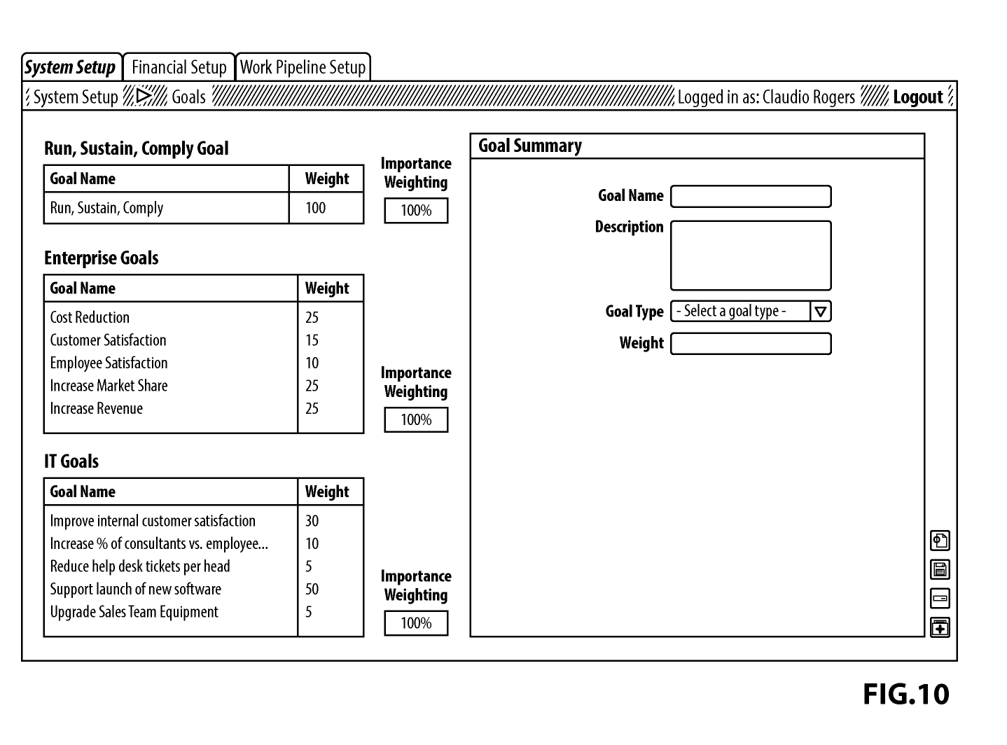

The user may select the Goals screen depicted in FIG. 10 from the main System setup screen. The system includes pre-defined objectives for convenience, including Increase Revenue, Reduce Costs, Employee Satisfaction, etc. Other objectives may be added by the user.

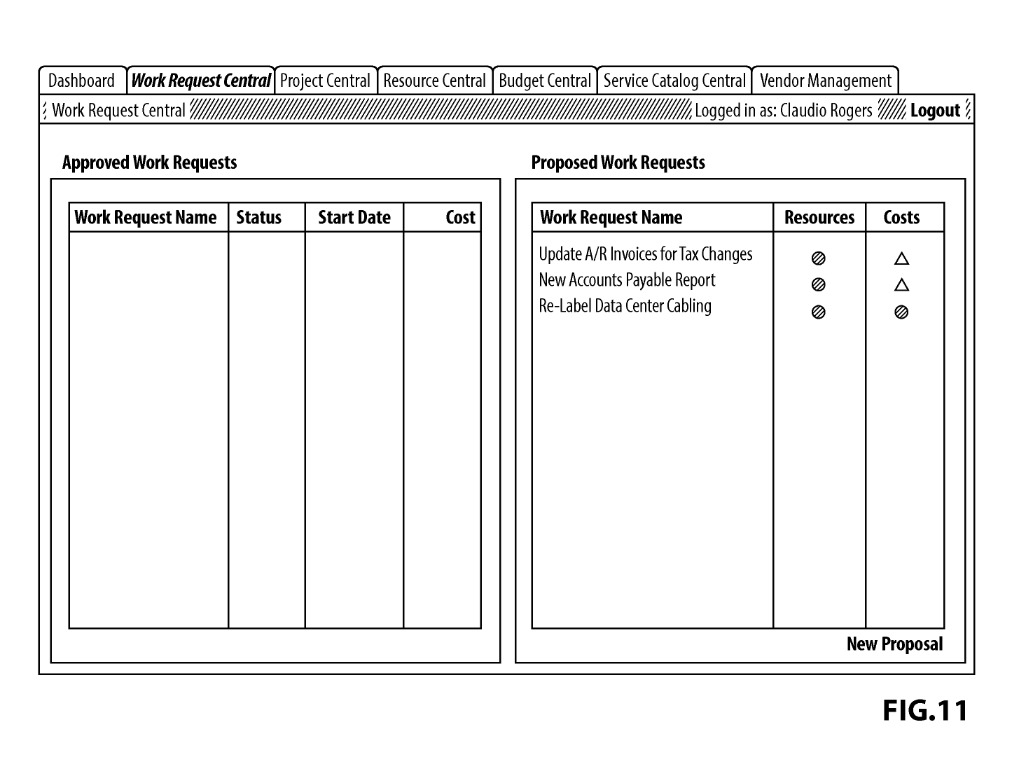

The user may manage work requests by selecting the Work Request Central screen of FIG. 11 to display the Work Request Central. A work request is a job deemed by the user to be too small to be a project but to not be included as regular day to day work. This tab may be used to store, monitor and evaluate all work requests. Work Request status may be displayed as ‘Approved Work Requests’ and ‘Proposed Work Requests’.

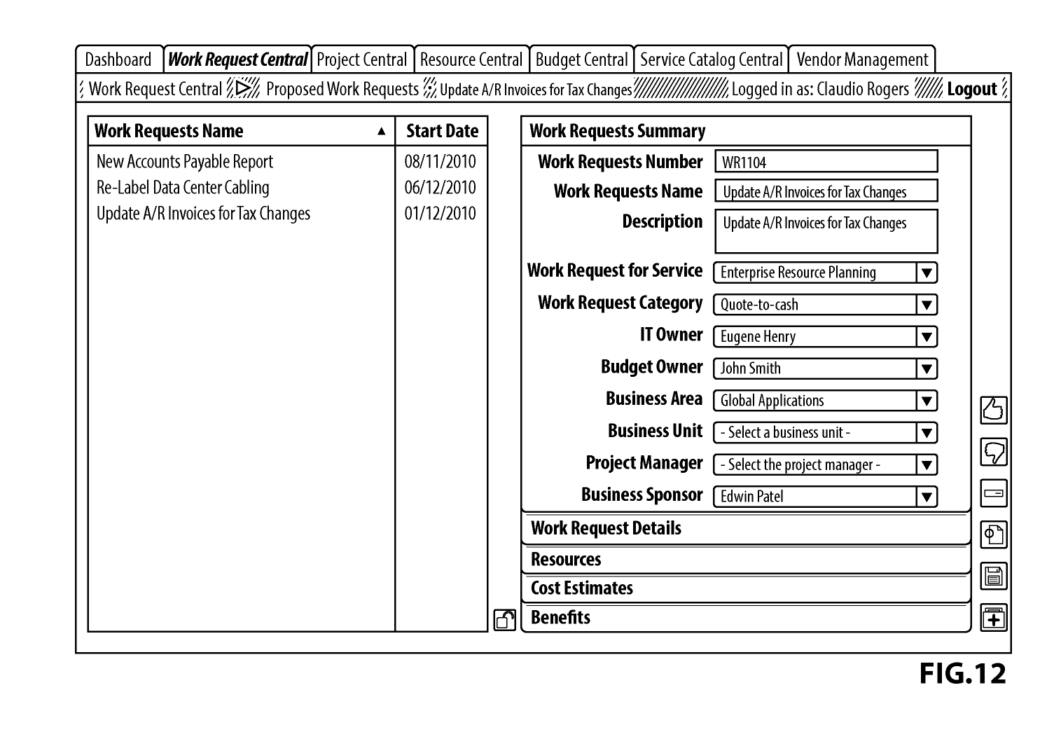

The user may enter summary information on a work request, as shown in FIG. 12 including assigned tracking number, request name, description, and request type. For example, the request type may be Sustainment, a work request that needs to be completed to keep the business running, or Transformation, a request that makes a change to or transforms the IT department. The user may assign Category, Owner, Sponsor and Business Unit to the work request. Start and complete dates may be entered, as may goal and other details as appropriate. Optionally, relevant documents may be attached to the work request.

For each Work Request, a traffic light system of indicators and completion ticks may be selected and displayed. A red square indicates no data provided, a yellow diamond indicates data partially completed, and a green circle indicates data fully completed. A tick box may be filled to approve or complete a work request. The user may select a desired work request to view, edit or enter new work requests.

The user may view, edit and input new resources, that is individuals and skill sets. The user may select the name of an individual then indicate if that person is a generalist or is being selected for one or more special skills. User may indicate resource details, including full or part time availability, start and end date required, and number of days per week and number of hours per day resource will be allocated to the work request. New resources may be added through the Resources tab.

Once the user saves the resource allocations, the user is returned to the Work Request Central screen which will now indicate a green circle for resources to indicate completion. The user may track and assign all costs of a work request at the Work Requests Costs screen. Two forms are displayed, namely, ‘Add/Edit Work Request Cost’ and ‘Cost Summary’. Costs may be added, amended or deleted. The user may select ‘Cost Category’, and add a description, cost assumptions, quantity and costs, dates and other details as necessary. Recurring costs may be indicated. Once costs details have been amended, the user may select ‘Finish Adding Costs’ to return to the Work Request Central screen, which will now display a green circle for Costs status.

The user may select the ‘Benefits’ bar from the ‘Proposed Work Request’ screen to view, edit and input the benefits relating to a selected work request. A description and value of all benefits may be added. Once all resources and costs have been assigned, all status indicators will be green, permitting the user to approve a Work, Request by selecting the tick box for approval. Work requests may be marked in the system as On Hold, Started, or Finalized. Once a work request is finished, it can be removed from the approved work request list.

The user may manage a project pipeline from start to finish; from ranked cost benefit appraisal through to project completion and review, including cost-benefit assessment, appraisal, prioritization, approval, management, tracking, evaluation, completion and review.

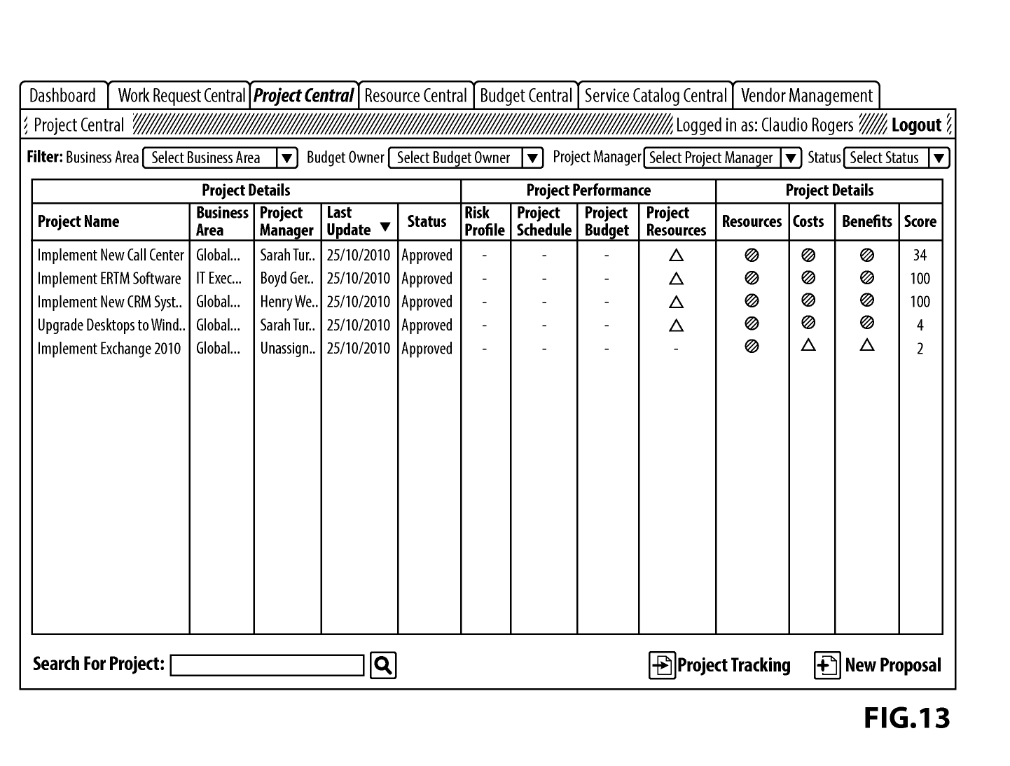

The user may select the Project Central screen as depicted in FIG. 13 which displays the status of all proposed and approved projects and allows the user to rank proposed projects in terms of attractiveness based on overall project score. Project score is a combination of financial project score and non-financial project score. A similar Traffic Light Indicator system and Ticks is used for Projects as is used for Work Requests. Data entry for Projects is similar to the Work Request data entry as described above.

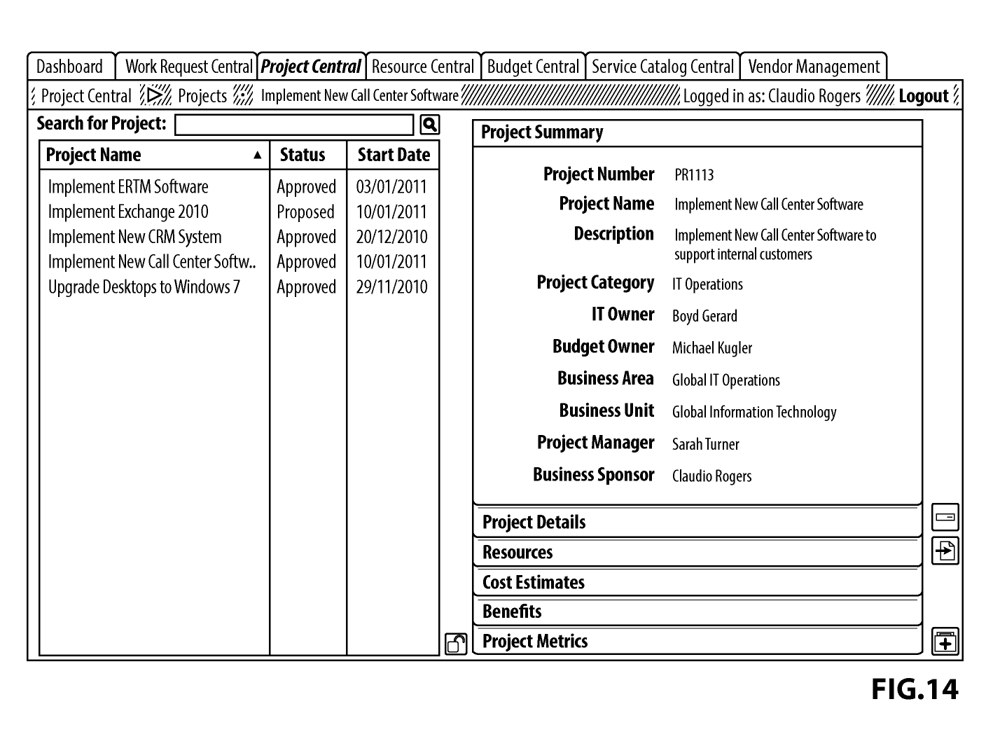

Users may also view, enter or edit a Project Summary, as shown in FIG. 14. The system is set to default that the project is a capital cost. To over ride this, the user may tick the cost over ride box and select capital cost or operational cost, and may select ‘Cost Category’ and ‘SC Link’ (service catalog link), and add description, relevant dates, costs and other details as necessary.

The user may evaluate return on investment (ROI) and other key financial metrics. The user may appraise project hurdle rates against company hurdle rates and other proposed projects by selecting the ‘ROI/Rater’ bar to display the return on investment and rank of this project versus others, and may select the ‘ROI Calculator’ button to load the ROI Calculator speedometer screen. ROI rates will be 0-90 if the company has not recovered its investment, 100 if investment equals return, break even point has been reached, and profit is zero, and at greater than 100 if return is greater than investment and profit is being made. For example, an ROI of 200 indicates the company has doubled its investment and profit has equaled investment.

The user may select the Projects Pipeline dashboard to compare and approve proposed projects by clicking on the navigation bar or ‘Project Pipeline’ tab. Once all indicators for a Proposed Project are green, the user may approve the project by ticking the approval box which appears once the project tile is selected.

Approved projects may be edited by the user manually changing the status indicators for an approved project. Once a project is finished, it may be finalized and removed from the project list by selecting the project title and ticking the box to indicate completion of the project. Once completed, the item will be removed from table.

The user may track company usage of their people and skills on day-to-day tasks, work requests and projects in order to evaluate its labour force's spare work capacity, and flag when staff usage is close to full capacity, thereby identifying the need to train or recruit to deal with business requirements.

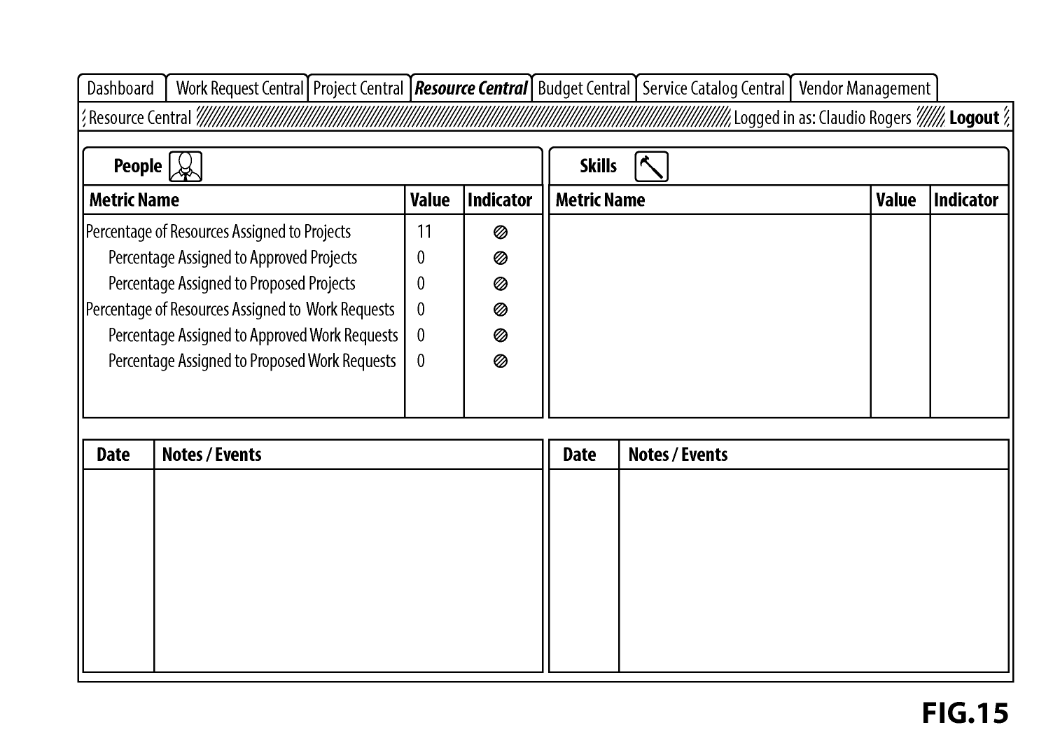

The user may select the Resource Central Tab to load the Resource Central screen shown in FIG. 15. A Table of Metrics and Notes/Events are displayed, indicating the percentage of total resources assigned to work requests and projects; the status indication on resource use, whether green for low use (spare capacity) or red for high use (near capacity), and scroll through notes and events relating to a selected calendar quarter for planning purposes. The user may select, view, add, edit and delete ‘People’ and ‘Skills’.

Contracts may be added to a resource by selecting the ‘Show Contracts’ icon to display a Contracts box under the resource list. An individual's skill set may be amended by the user inputting experience and competency levels for that individual.

The user may monitor budget scenarios. Budgets may be viewed from the perspective of projects and work requests, assets and resources, and/or time.

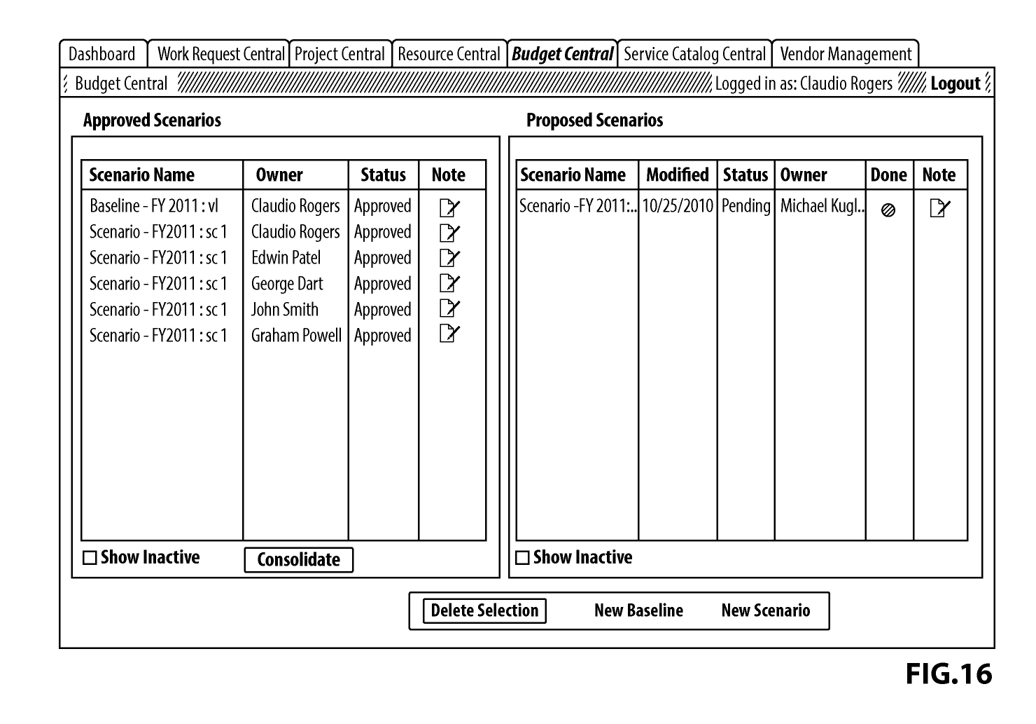

By selecting the ‘Budgets’ Tab, the user will load the Budgets Central screen shown in FIG. 16. The user may display Summary budget spend tables, a detailed budget spend report, and Budget start and end date. The user may also display Approved & Proposed tabs to view the approved & proposed detailed reports. The user may amend Projects & Work Request costs and budget periods to view differing scenarios. The user may manage and track internal services, systems and configuration items and how they interrelate, to enable the user to identify items that are reliant on one another.

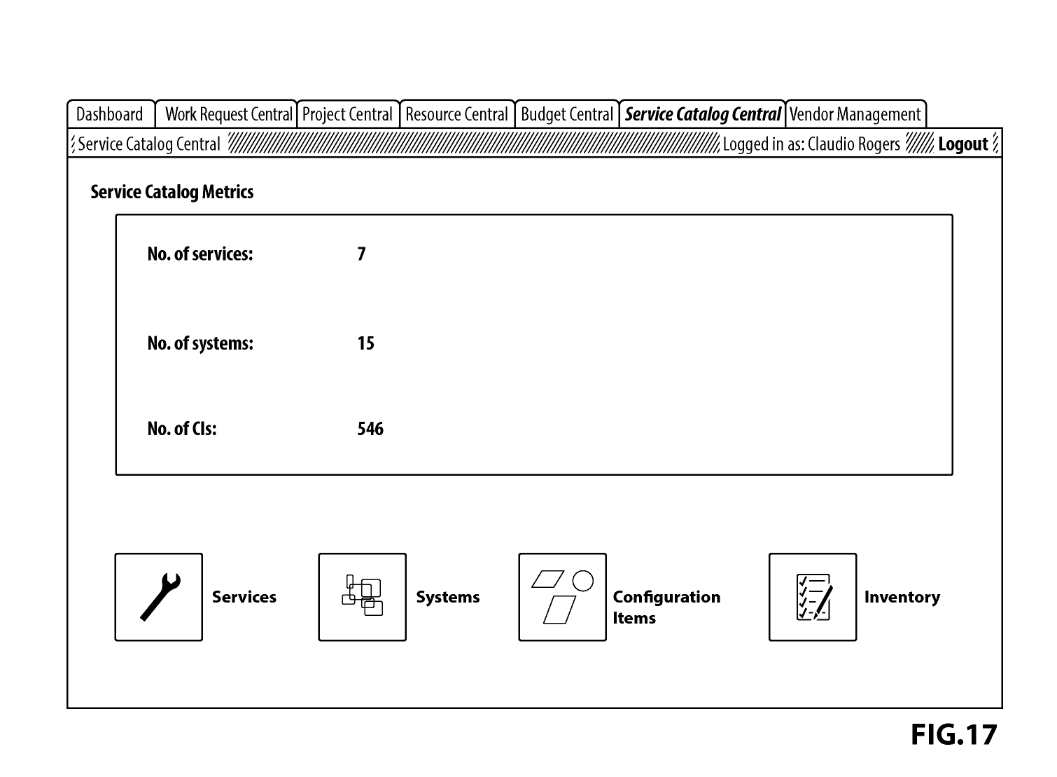

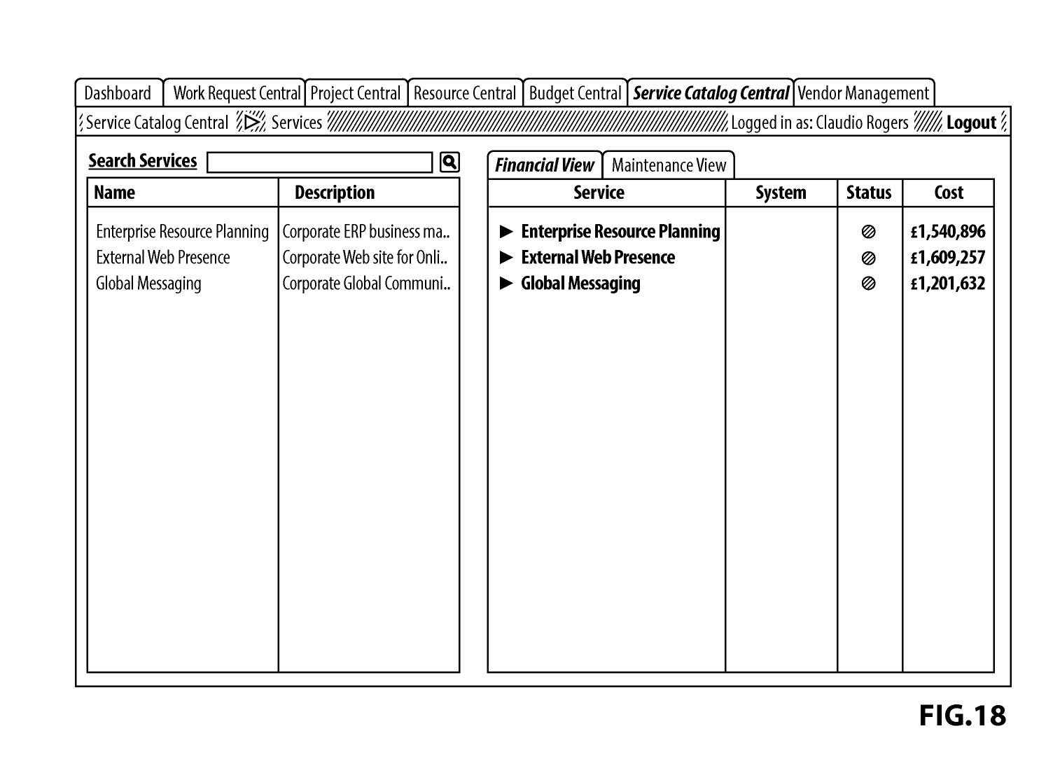

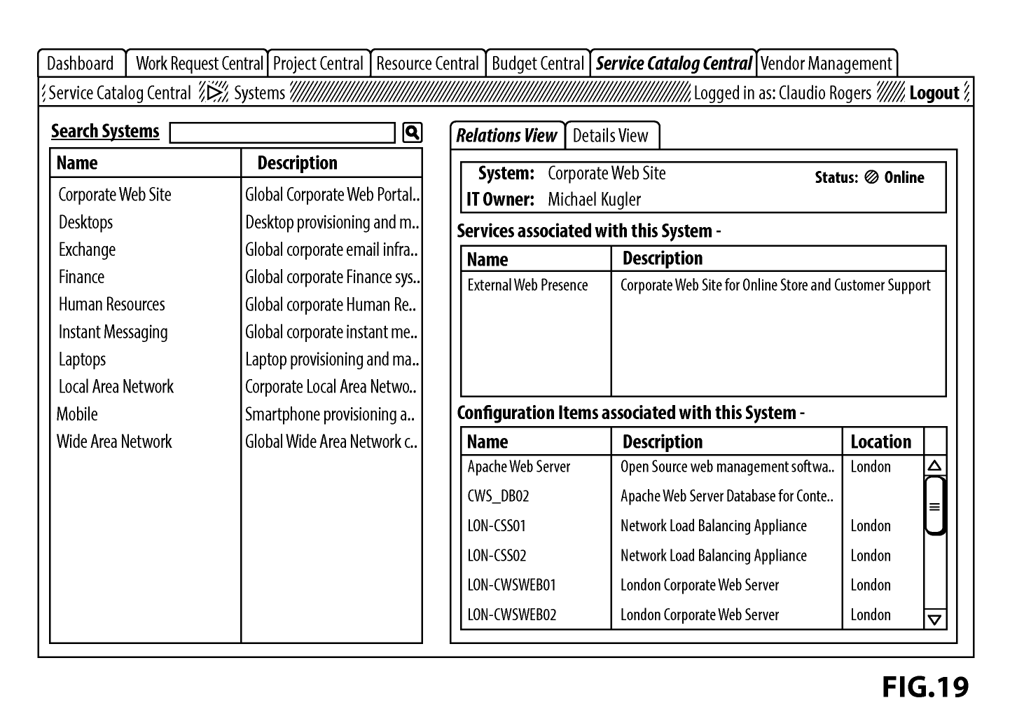

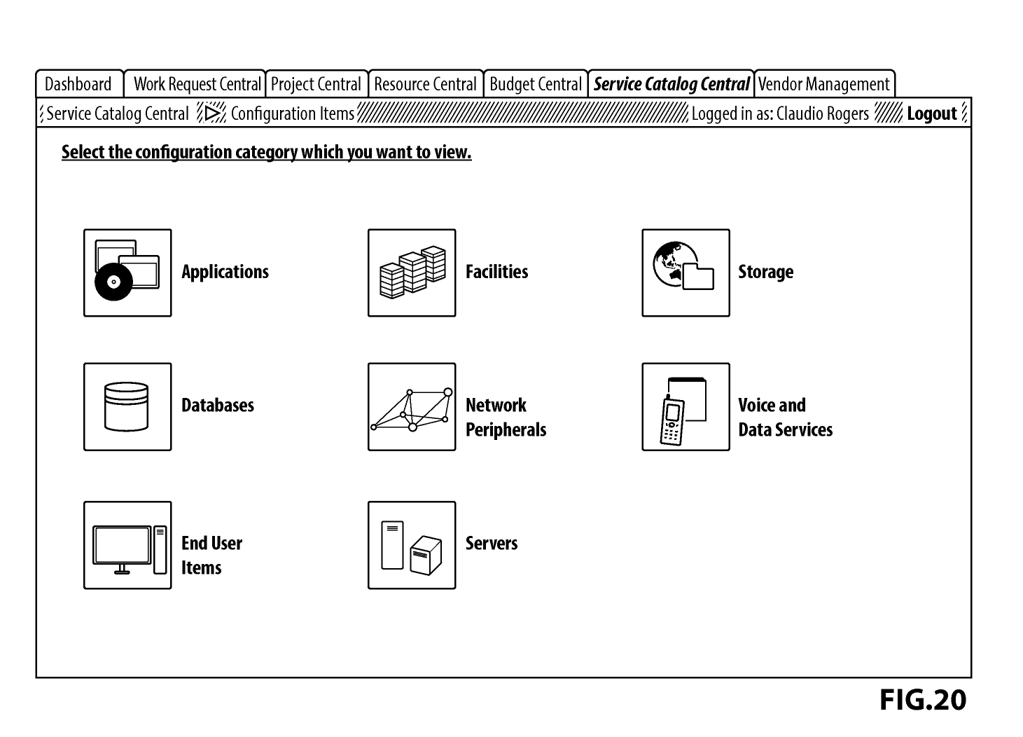

The user may select the ‘Service Catalog’ Tab to display the Service Catalog Central screen of FIG. 17. Details of any item within the Services, Systems or Configuration Items tables may be viewed, as depicted in FIGS. 18, 19, and 20. Services are pre-defined by the administrator at set-up, but the user may new systems and configuration items.

The user may enter information pertaining to ‘Configuration Details’ and ‘Vendor & Asset Details’. Configuration Items may be linked to Parent Configuration Items. Systems may be added or edited, and Configuration Items may be linked to Systems, and Systems may be linked to Services, or these links may be removed.

Configuration Items which may be viewed and managed include applications, databases, end user items, facilities, network peripherals, servers, storage, and voice and data services.

The user may also manage and organize vendors and contracts, and centrally store all agreements, dates, terms, details and notes. Electronic copies of contracts and notes of any description may be attached and centrally stored for ease of access.

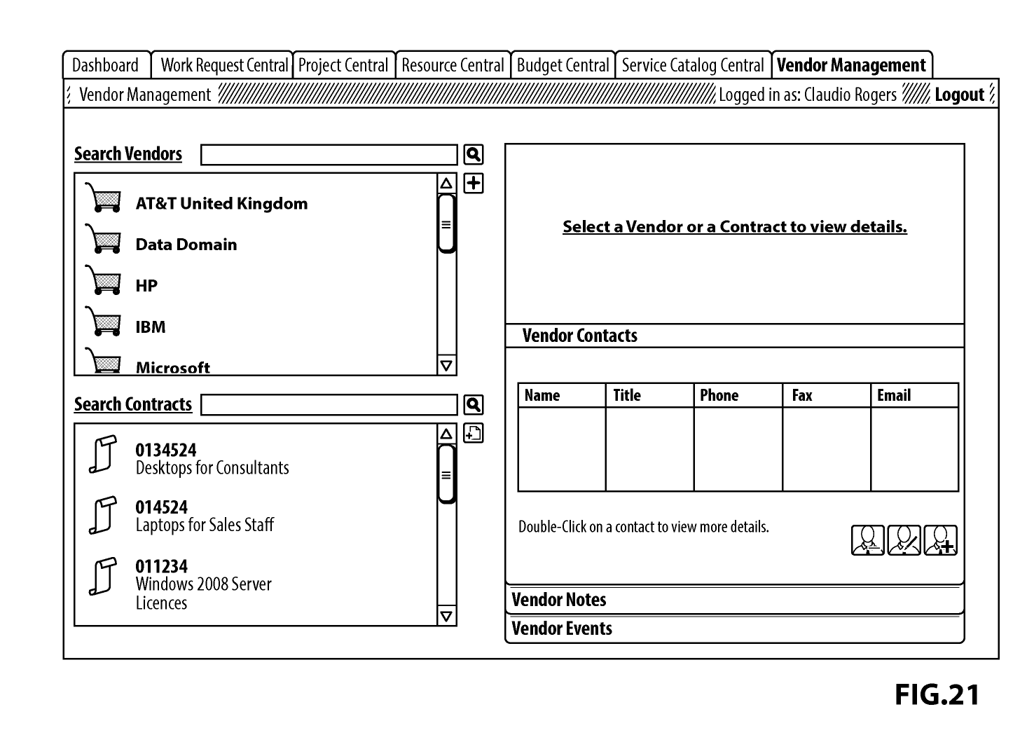

The user may click on the ‘Vendors’ Tab to load the Vendors Management screen depicted in FIG. 21. The user may select and view details of a Vendor, and may view Contracts related to the Vendor. New Vendors and Contracts may be added or amended. Details of Contract Costs, Terms and Conditions, Quantities, Dates and Accountability may be entered. The Contract may be attached as an electronic document link. The user may indicate Term Type and select Payment, Performance or Provision for term type.

1. A computer-implemented method of enterprise data mining comprising the steps of:
collecting data from a plurality of users of a multi-tenant hosted database in a cloud computing environment;
selecting data that is relevant to a desired output from among the collected data;
pre-processing the selected data by comparing data among a selected sub-group of users; and
generating a report from the data in response to a received request from a client.

2. The computer-implemented method of claim 1, wherein the system architecture includes a rules engine and a related Rete algorithm to enhance the speed of collection and abstraction of data from the database.

3. The computer-implemented method of claim 1, wherein the data pertaining to each user is associated with an encryption key unique to that user.

4. The computer-implemented method of claim 1, wherein all of a plurality of users may map a user-specific lexicography to a master terminology.

5. The computer-implemented method of claim 1, wherein a project being managed may be ranked for priority according to both financial and non-financial criteria.

6. The computer-implemented method of claim 1, wherein both approved projects and proposed projects may be simultaneously viewed and managed.

7. A computer program product in a cloud computing system comprising a computer readable memory storing computer executable instructions thereon that when executed by a computer perform the method steps of claim 1.

8. A computer-implemented method in an enterprise cloud computing system for information technology management and data extraction in a multi-tenant environment, comprising the steps of:
providing a set of multi-tenant hosted software modules;
providing access to the software modules to each of a plurality of remote users via the Internet through web browsers;
providing a multi-tenant shared database associated with the software modules;
collecting user data within the multi-tenant database;
aggregating the data;
manipulating the data; and
reporting the data.

9. The computer-implemented method of claim 8, wherein the set of software modules comprises one or more of:
an information technology management module;
a financial management module;
a portfolio management module;
a project management module;
a resource management module; and
an operations management module.

10. The computer-implemented method of claim 8, wherein each user may use metadata to configure the set of software modules to user-specific specifications without altering other users' metadata configurations.

11. A computer program product in a cloud computing system comprising a computer readable memory storing computer executable instructions thereon that when executed by a computer perform the method steps of claim 8.

12. A database system in a cloud computing system comprising:
a database server, which stores a plurality of databases; and
a control server for controlling the database system, wherein the control server comprises means for accessing and operating any one or more of a set of software modules associated with the database server, wherein the database is used to store for each user of the application:
information technology management information;
financial information;
portfolio management information;
project management information;
resource management information; and
operations management information.

13. The database system of claim 12 wherein the control server further comprises means for preventing access by each user to the data of any other user.
